(19) United States
(12) Patent Application Publication
(10) Pub. No.: US 2026/0339717 A1
(43) Pub. Date: Oct. 29, 2026

(54) METHOD AND SYSTEM FOR GENERATING A MULTI-MODAL LARGE LANGUAGE MODEL COMPUTER TASK AUTOMATION AGENT FOR AUTONOMOUS EXECUTION OF A VIRTUAL ACTION

(71) Applicant: JPMorgan Chase Bank, N.A., New York, NY (US)

(72) Inventors: Gaurav VERMA, Fulton, GA (US); Rachneet KAUR, Manhattan, NY (US); Nishan SRISHANKAR, Secaucus, NJ (US); Zhen ZENG, Ypsilanti, MI (US); Tucker Richard BALCH, Suwanee, GA (US); Manuela VELOSO, New York, NY (US)

(73) Assignee: JPMorgan Chase Bank, N.A., New York, NY (US)

(21) Appl. No.: 19/187,564

(22) Filed: Apr. 23, 2025

(51) Int. Cl. G06F 9/50

(52) U.S. Cl. CPC G06F 9/5027

(57) ABSTRACT

A method and system for generating a multi-modal large language model (LLM) computer task automation agent for autonomous execution of a virtual action is provided. The method includes receiving an input data with a virtual task request and a screenshot of a computer screen associated with the virtual task request. The method also includes implementing a multi-modal LLM based on at least one from among a first multi-modal LLM with proprietary weights and a second multi-modal LLM with open-source weights. The method also includes generating a multi-modal LLM computer task automation agent based on the implemented multi-modal LLM by performing at least one from among a first training process corresponding to the first multi-modal LLM and a second training process corresponding to the second multi-modal LLM. The method also includes executing the multi-modal LLM computer task automation agent to autonomously perform a virtual action.

### FIELD OF THE DISCLOSURE

This technology generally relates to methods and systems for generating a multi-modal large language model computer task automation agent for autonomous execution of a virtual action.

### BACKGROUND INFORMATION

In the context of operational procedures, virtual agents performing automated web-based tasks/actions with minimal human intervention can significantly boost personal and workplace productivity. Indeed, when such web-based tasks/actions consistently need to be performed on a constant recurring and large-scale basis across countless individuals and/or organizations, this results in time and resource inefficiencies.

While current virtual agents with machine learning (ML) models can perform a web-based task/action, these current virtual agents with ML models are often generalized models that have difficultly adapting to new situations such as new tasks, websites, domains, etc. That is, they mainly just perform the same/similar tasks on websites or domains that they are familiar with. Adapting them to new situations often is a computationally costly and resource costly endeavor. This is because adapting the current virtual agents involve large-scale pre-training and fine-tuning of the ML models that make up the current virtual agents.

Accordingly, there is a need for techniques to generate improved virtual agents by improving the training and fine-tuning of the underlying ML models to adapt them to new situations.

### SUMMARY

The present disclosure, through one or more of its various aspects, embodiments, and/or specific features or sub-components, provides, inter alia, various systems, servers, devices, methods, media, programs, and platforms for generating a multi-modal large language model computer task automation agent for autonomous execution of a virtual action.

According to an aspect of the present disclosure, a method of generating a generating a multi-modal large language model computer task automation agent for autonomous execution of a virtual action may be provided. The method may be implemented by at least one processor. The method may include receiving an input data comprising a virtual task request and a screenshot of a computer screen associated with the virtual task request. The method may also include implementing a multi-modal large language model (LLM) based on at least one from among a first multi-modal LLM comprising proprietary weights and a second multi-modal LLM comprising open-source weights. The method may also include generating a multi-modal LLM computer task automation agent based on the implemented multi-modal LLM by performing at least one from among a first training process corresponding to the first multi-modal LLM and a second training process corresponding to the second multi-modal LLM. The method may also include executing the multi-modal LLM computer task automation agent to autonomously perform a virtual action on the computer screen to complete the virtual task request.

The input data may further include at least one from among a speech data and an audio data. The virtual action may include at least one from among a clicking action, a typing action, and a selection action.

The first training process may include: constructing a prompt based on a prompt technique comprising a reasoning and an action (ReAct) prompt technique, and training iteratively the first multi-modal LLM with the constructed prompt based on a few-shot in-context learning (ICL) process in generating a next virtual action associated with a current graphic user interface (GUI) state to complete the virtual task request.

The few-shot ICL process may include deconstructing a predetermined number of a demonstration of a user performing the virtual action on a training computer screen into a series of sequences. The series of sequences may include a screenshot of the training computer screen, filtering of hypertext markup language (HTML) elements on the training computer screen, and a selection by the user of the HTML elements. The predetermined number of the demonstration may include a number of up to two.

The second training process may include training the second multi-modal LLM based on a meta-learning technique comprising a first-order approximation of a model agnostic meta-learning technique. The second training process may also include fine-tuning the second multi-modal LLM based on an inner loop update process of the meta-learning technique that fine-tunes the second multi-modal LLM on at least one virtual task from the computer screen. The second training process may also include updating the second multi-modal LLM by updating parameters of the second multi-modal LLM based on an outer loop update process of the meta-learning technique that backpropagates loss gradients.

The method may further include evaluating the generated multi-modal LLM computer task automation agent based on a success rate percentage associated with the completion of the virtual task request.

The method may further include evaluating the generated multi-modal LLM computer task automation agent based on granular metrics that may include: an accuracy metric associated with a correct prediction of a hypertext markup language (HTML) element on the computer screen for the autonomously performing of the virtual action, a F1 score associated with a correct virtual action, a first success rate percentage associated with the autonomously performing the virtual action, and a second success rate percentage associated with the completion of the virtual task request.

According to another embodiment, a computing apparatus for generating a multi-modal large language model computer task automation agent for autonomous execution of a virtual action may be provided. The computing apparatus may include: a processor; a memory; a display; and a communication interface coupled to each of the processor, the memory, and the display.

The processor may be configured to receive an input data comprising a virtual task request and a screenshot of a computer screen associated with the virtual task request. The processor may also be configured to implement a multi-modal large language model (LLM) based on at least one from among a first multi-modal LLM comprising proprietary weights and a second multi-modal LLM comprising open-source weights. The processor may also be configured to generate a multi-modal LLM computer task automation agent based on the implemented multi-modal LLM by performing at least one from among a first training process corresponding to the first multi-modal LLM and a second training process corresponding to the second multi-modal LLM. The processor may also be configured to execute the multi-modal LLM computer task automation agent to autonomously perform a virtual action on the computer screen to complete the virtual task request.

The input data may further include at least one from among a speech data and an audio data. The virtual action may include at least one from among a clicking action, a typing action, and a selection action.

The processor may be further configured to perform the first training process by constructing a prompt based on a prompt technique comprising a reasoning and an action (ReAct) prompt technique. The processor may be further configured to train iteratively the first multi-modal LLM with the constructed prompt based on a few-shot in-context learning (ICL) process in generating a next virtual action associated with a current graphic user interface (GUI) state to complete the virtual task request.

The processor may be further configured to train iteratively the first multi-modal LLM with the constructed prompt based on the few-shot ICL process by deconstructing a predetermined number of a demonstration of a user performing the virtual action on a training computer screen into a series of sequences. The series of sequences comprise a screenshot of the training computer screen, filtering of hypertext markup language (HTML) elements on the training computer screen, and a selection by the user of the HTML elements. The predetermined number of the demonstration may include a number of up to two.

The processor may be further configured to perform the second training process by training the second multi-modal LLM based on a meta-learning technique comprising a first-order approximation of a model agnostic meta-learning technique. The processor may also be configured to fine-tuning the second multi-modal LLM based on an inner loop update process of the meta-learning technique that fine-tunes the second multi-modal LLM on at least one virtual task from the computer screen. The processor may also be configured to update the second multi-modal LLM by updating parameters of the second multi-modal LLM based on an outer loop update process of the meta-learning technique that backpropagates loss gradients.

The processor may be further configured to evaluate the generated multi-modal LLM computer task automation agent based on a success rate percentage associated with the completion of the virtual task request.

The processor may be further configured to evaluate the generated multi-modal LLM computer task automation agent based on granular metrics which may include: an accuracy metric associated with a correct prediction of a hypertext markup language (HTML) element on the computer screen for the autonomously performing of the virtual action, a F1 score associated with a correct virtual action, a first success rate percentage associated with the autonomously performing the virtual action, and a second success rate percentage associated with the completion of the virtual task request.

According to yet another embodiment, non-transitory computer readable storage medium storing instructions for generating a multi-modal large language model computer task automation agent for autonomous execution of a virtual action may be provided. The non-transitory computer readable storage medium may include executable code which, when executed by a processor, may cause the processor to receive an input data comprising a virtual task request and a screenshot of a computer screen associated with the virtual task request. The processor may also implement a multi-modal large language model (LLM) based on at least one from among a first multi-modal LLM comprising proprietary weights and a second multi-modal LLM comprising open-source weights. The processor may also generate a multi-modal LLM computer task automation agent based on the implemented multi-modal LLM by performing at least one from among a first training process corresponding to the first multi-modal LLM and a second training process corresponding to the second multi-modal LLM. The processor may also execute the multi-modal LLM computer task automation agent to autonomously perform a virtual action on the computer screen to complete the virtual task request.

The input data further may include at least one from among a speech data and an audio data. The virtual action may include at least one from among a clicking action, a typing action, and a selection action.

The non-transitory computer readable storage medium may further cause the processor to perform the first training process by constructing a prompt based on a prompt technique comprising a reasoning and an action (ReAct) prompt technique. The processor may also train iteratively the first multi-modal LLM with the constructed prompt based on a few-shot in-context learning (ICL) process in generating a next virtual action associated with a current graphic user interface (GUI) state to complete the virtual task request.

The non-transitory computer readable storage medium may further cause the processor to evaluate the generated multi-modal LLM computer task automation agent based on granular metrics that may include: an accuracy metric associated with a correct prediction of a hypertext markup language (HTML) element on the computer screen for the autonomously performing of the virtual action, a F1 score associated with a correct virtual action, a first success rate percentage associated with the autonomously performing the virtual action, and a second success rate percentage associated with the completion of the virtual task request.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for generating a multi-modal large language model (LLM) computer task automation agent for autonomous execution of a virtual action.

FIG. 4 illustrates a flowchart of a process diagram for generating a multi-modal LLM computer task automation agent for autonomous execution of a virtual action according to an embodiment.

FIG. 5 illustrates an example detailed framework for generating a multi-modal LLM computer task automation agent for autonomous execution of a virtual action according to an embodiment.

FIG. 6 illustrates an example evaluation strategy for a meta-learning process as part of generating a multi-modal LLM computer task automation agent for autonomous execution of a virtual action according to an embodiment.

FIG. 7 illustrates an example general overview process for generating a multi-modal LLM computer task automation agent for autonomous execution of a virtual action according to an embodiment.

### DETAILED DESCRIPTION

Virtual agents performing automated web-based tasks with minimal human intervention can significantly boost personal and workplace productivity. A prevalent interaction may involve a user providing instruction in various modalities (e.g., natural language instruction, voice/speech/audio, text, etc.), and the virtual agent autonomously executing the necessary actions on the computer screen to complete the user-assigned task. An example of the instruction may be requesting that the virtual agent book a flight on an airline's website.

Large language models (LLMs) can understand instructions, plan, and predict structured outputs, serving as underlying machine learning (ML) models for such virtual agents. The status quo has made some progress in automating web-based tasks using LLM-based virtual agents via e.g., extensive pre-training and fine-tuning to predict actions using language instructions and a hypertext markup language (HTML) or document object model (DOM).

While the status quo has made some progress, challenges remain in adapting the LLM-based virtual agents to new situation such as new tasks, websites, and/or domains. The ability to adapt these LLM-based computer task automation agents to new situations such as new tasks, websites, and/or domains is a critical component to ensure their broad applicability and usability by a wide breadth of users and organizations.

The techniques in the status quo to adapt these LLM-based computer task automation agents to new situations often relies on large-scale pre-training or fine-tuning. However, this current technique. The technique in the status quo is highly costly in terms of computations, resources (e.g., time, money, network, computing environment), etc. Additionally, it is also noted that regardless of a pre-training scale, some tasks and domains will remain unseen, such as proprietary workflows and enterprise websites, which is not accounted for in the status quo's techniques.

Therefore, the present application describes a framework for generating multi-modal LLM computer task automation agent for data-efficient adaptability without relying solely on large-scale pre-training and fine-tuning like that in the status quo. Specifically, the present application presents a framework to generate a multi-modal LLM computer task automation agent that can be trained and adapted to unseen computer screens, e.g., unseen websites and domains. The framework may include few-shot in-context learning (ICL) process with a prompt technique or meta-learning depending on whether the base/underlying multi-modal LLM has proprietary weights or open-source weights. While the framework describes ICL or meta-learning, any applicable few-shot learning technique may be utilized. The framework may also include the incorporation of a predetermined number of a user demonstration performing a virtual action on a training computer screen. For instance, only a handful of user demonstrations (e.g., n=1 or n=2) may be needed as part of the process for training and adapting the multi-modal LLM computer task automation agent to new situations.

Indeed, experiments regarding the framework of the present application have generated results showing that the framework, which may include the incorporation of just a handful of in-context multi-modal demonstration (visual snapshot+HTML information+1 or 2 user demonstrations), can result in an increase in a task success rate of e.g., 3.36% to 7.21% on unseen websites and domains. This can correspond to a relative increase of e.g., 21.03% to 65.75% over the status quo.

Thus, the present application improves on the status quo and provides a technological improvement by disclosing a framework with techniques and processes related to the generation of the multi-modal LLM computer task automation agent, which includes its training and adaptation to new situations and to autonomously execute a virtual action on such a computer screen with e.g., a webpage/website. This may be achieved in a manner as described in the present application. This framework and the generation of the multi-modal LLM computer task automation agent is further described below.

For these various reasons, the present application provides a technological improvement of the status quo. Further details of the present application are provided below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

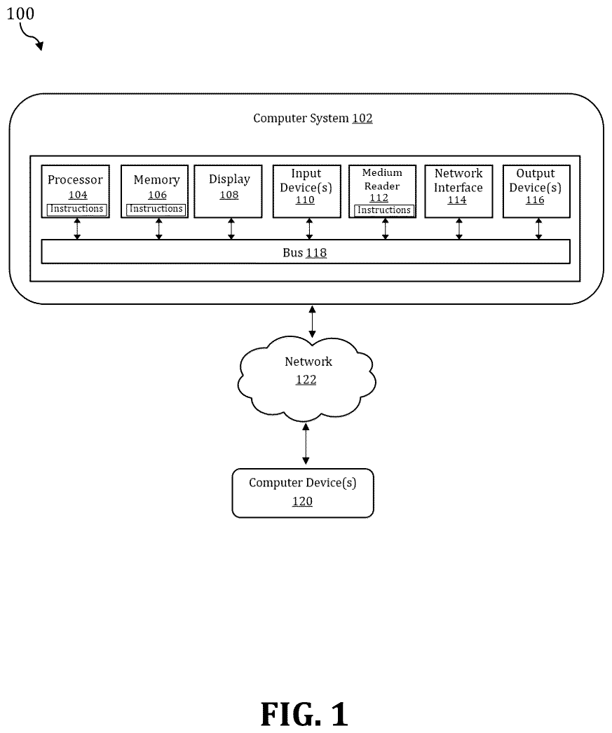

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for generating a multi-modal LLM computer task automation agent for autonomous execution of a virtual action.

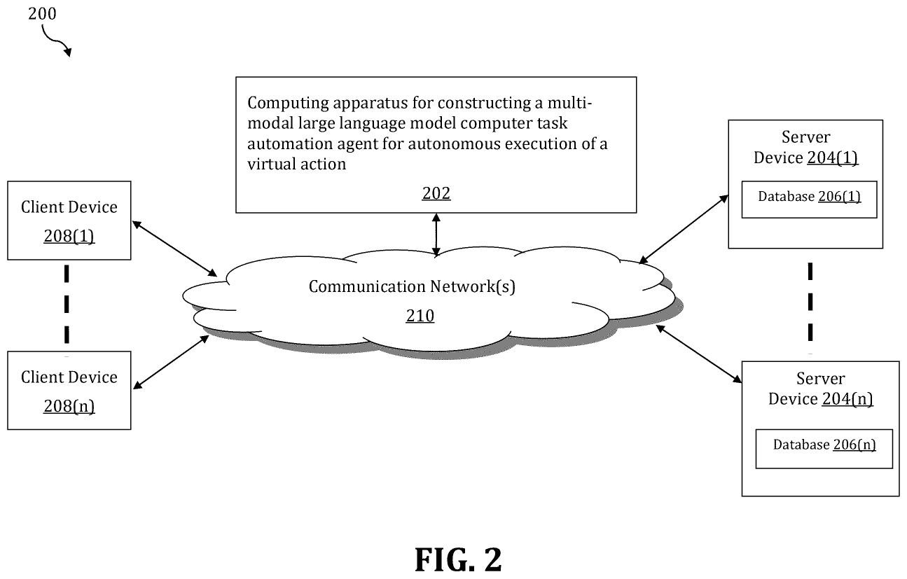

Referring to FIG. 2, a network diagram of a network environment 200 for generating a multi-modal LLM computer task automation agent for autonomous execution of a virtual action may be illustrated. In an embodiment, the method may be executable on any networked computer platform, such as, for example, a personal computer (PC).

The methods for generating a multi-modal large language model computer task automation agent for autonomous execution of a virtual action may be implemented by a computing apparatus 202 that implements a generating a multi-modal large language model computer task automation agent for autonomous execution of a virtual action. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for generating a multi-modal large language model computer task automation agent for autonomous execution of a virtual action.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

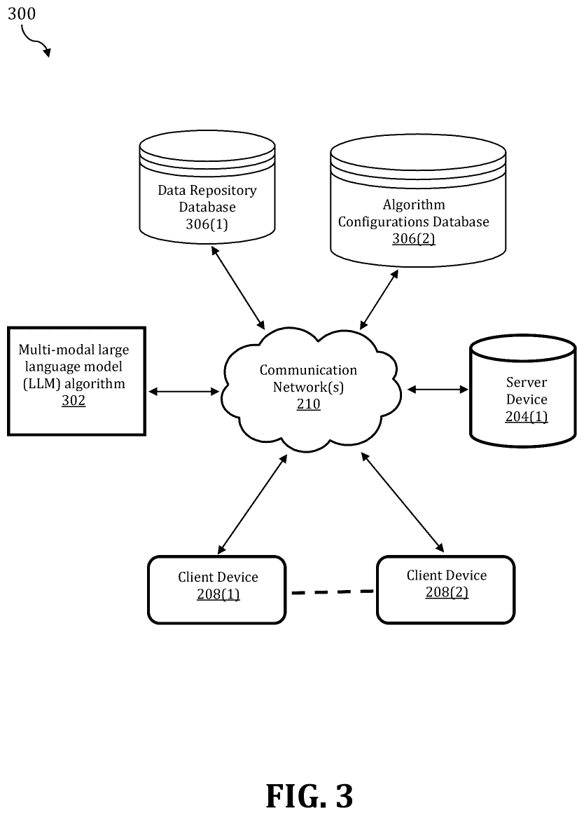

The computing apparatus 202 may be described and illustrated in FIG. 3 as may include a multi-modal large language model (LLM) algorithm 302, although it may include other rules, algorithms, policies, modules, databases, or applications, for example. As will be described below, the multi-modal LLM algorithm 302 may be configured to implement method of generating a multi-modal large language model computer task automation agent for autonomous execution of a virtual action.

FIG. 3 illustrates a diagram of a system environment 300 for implementing method of generating a multi-modal LLM computer task automation agent for autonomous execution of a virtual action by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The multi-modal LLM algorithm 302 may be configured to access these databases for implementing the method of generating a multi-modal LLM computer task automation agent for autonomous execution of a virtual action.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

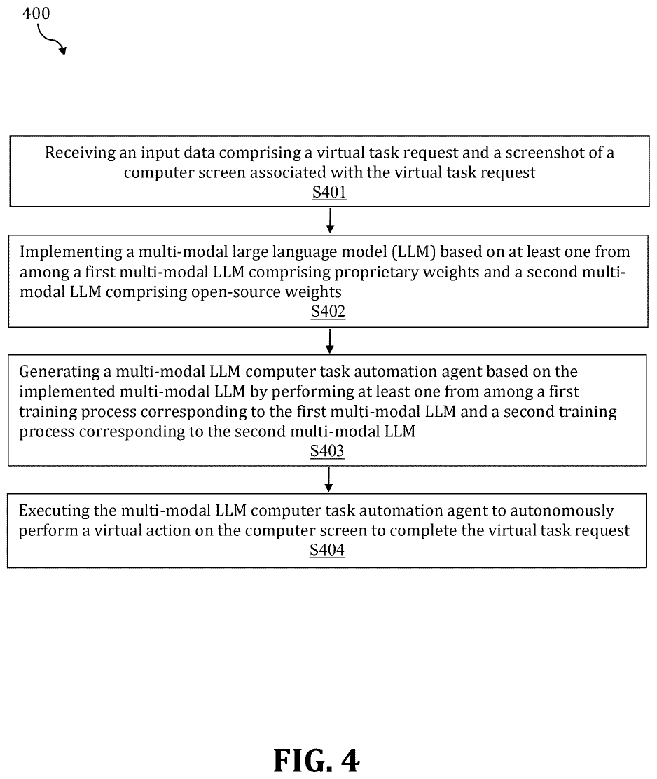

The multi-modal LLM algorithm 302 may execute a process implementing method of generating a multi-modal LLM computer task automation agent for autonomous execution of a virtual action. The process for generating a multi-modal LLM computer task automation agent for autonomous execution of a virtual action may be generally indicated at flowchart 400 in FIG. 4.

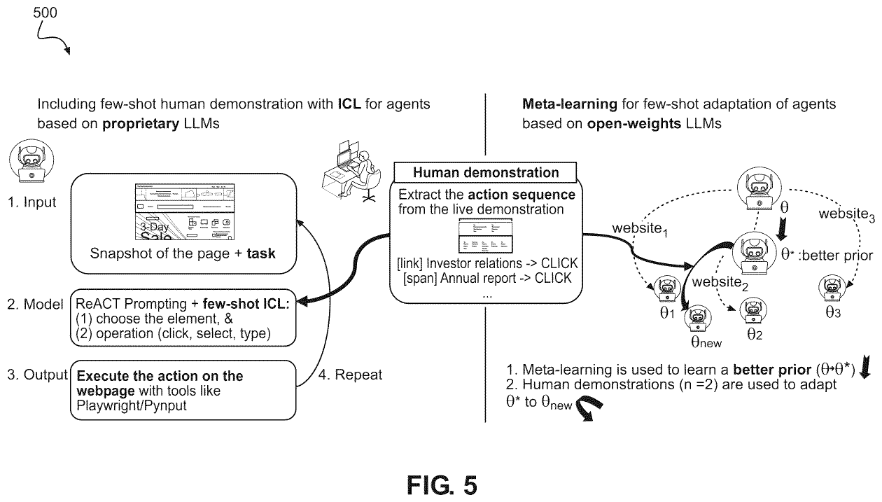

FIG. 4 illustrates a flowchart of a process diagram 400 of a process for generating a multi-modal LLM computer task automation agent for autonomous execution of a virtual action according to an embodiment. The process diagram 400 may be implemented by the system environment 300 of FIG. 3, a network environment 200 of FIG. 2, and the system 100 of FIG. 1. Further details of the various processes in FIG. 4 may be found in FIGS. 5-7.

At step S401 of the flowchart process 400, the computing apparatus 202 may receive an input data that may include a virtual task request and a screenshot of a computer screen associated with the virtual task request. The input data may further include at least one from among a speech data and an audio data. The virtual action may include at least one from among a clicking action, a typing action, and a selection action.

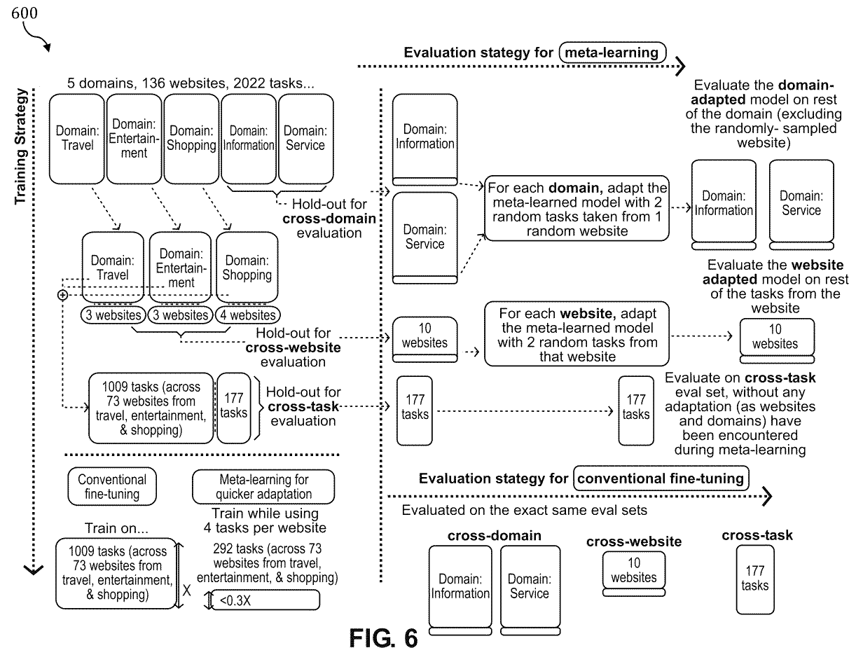

At step S402 of the flowchart process 400, the computing apparatus 202 may implement a multi-modal LLM based on at least one from among a first multi-modal LLM with proprietary weights and a second multi-modal LLM with open-source weights. The second multi-modal LLM may be, e.g., a 18 billion multi-modal LLM with a dedicated visual backbone to process graphic user interface (GUI) images. See FIGS. 5 and 6 for further details.

At step S403 of the flowchart process 400, the computing apparatus 202 may generate a multi-modal LLM computer task automation agent based on the implemented multi-modal LLM by performing at least one from among a first training process corresponding to the first multi-modal LLM and a second training process corresponding to the second multi-modal LLM.

The first training process may include constructing a prompt based on a prompt technique with a reasoning and an action (ReAct) prompt technique, and training iteratively the first multi-modal LLM with the constructed prompt based on a few-shot in-context learning (ICL) process in generating a next virtual action associated with a current GUI state to complete the virtual task request. It is noted that although the first training process describe ICL, any applicable few-shot learning technique may be utilized. Further details of the prompt technique and few-shot ICL process are provided in FIG. 5.

The few-shot ICL process may include deconstructing a predetermined number of a demonstration of a user performing the virtual action on a training computer screen into a series of sequences. The series of sequences may include a screenshot of the training computer screen, filtering of HTML elements on the training computer screen, and a selection by the user of the HTML elements. The predetermined number of the demonstration may include a number of up to two.

The second training process may include training the second multi-modal LLM based on a meta-learning technique comprising a first-order approximation of a model agnostic meta-learning technique. The second training process may also include fine-tuning the second multi-modal LLM based on an inner loop update process of the meta-learning technique that fine-tunes the second multi-modal LLM on at least one virtual task from the computer screen. The second training process may also include updating the second multi-modal LLM by updating parameters of the second multi-modal LLM based on an outer loop update process of the meta-learning technique that backpropagates loss gradients. It is noted that although the second training process describe meta-learning, any applicable few-shot learning technique may be utilized.

At step S404 of the flowchart process 400, the computing apparatus 202 may execute the multi-modal LLM computer task automation agent to autonomously perform a virtual action on the computer screen to complete the virtual task request.

Continuing with FIG. 4, the computing apparatus 202 may also evaluate the generated multi-modal LLM computer task automation agent based on a success rate percentage associated with the completion of the virtual task request. Additionally, the computing apparatus 202 may also evaluate the generated multi-modal LLM computer task automation agent based on granular metrics such as, but not limited to: an accuracy metric associated with a correct prediction of a hypertext markup language (HTML) element on the computer screen with e.g., a webpage, for the autonomously performing of the virtual action, a F1 score associated with a correct virtual action, a first success rate percentage associated with the autonomously performing the virtual action, and a second success rate percentage associated with the completion of the virtual task request. Further details are provided in FIG. 5 below.

FIG. 5 illustrates an example detailed framework 500 (or framework 500 for short) for generating a multi-modal LLM computer task automation agent for autonomous execution of a virtual action according to an embodiment as described in FIG. 4 at steps S401-S404.

The framework 500 may describe building multi-modal LLM web-agents for data-efficient adaptability with the need for large-scale pre-training and fine-tuning. Specifically, the framework 500 may describe how the multi-modal LLM computer task automation agents may be adapted (i.e., trained) to operate unseen computer screens with e.g., unseen webpages/websites and domains using just a predetermined number of the demonstration with a number of up to two demonstrations (e.g., n=1 or n=2). That is, with one or two user demonstrations.

The framework 500 may show on an input data at step 1, a model (such as the multi-modal LLM computer task automation agent) at step 2, an output at step 3, and a repeat at step 4 of the steps from 1-3. The input data may include a virtual task request and a screenshot of a computer screen associated with the virtual task request.

The framework 500 may also show the few-shot ICL process with a user demonstration for a multi-modal LLM with proprietary weights. The process 500 may also show a meta-learning process for a multi-modal LLM with open-source weights.

The framework 500 for generating multi-modal LLM computer task automation agent with few-shot learning may be based upon a base multi-modal LLM operating with proprietary weights or open-source weights. That is, the multi-modal LLM computer task automation agent may be generated based on an implementation of either a multi-modal LLM with proprietary weights or a multi-modal LLM with open-source weights. If a multi-modal LLM with propriety weights (this may be denoted as a first multi-modal LLM) is chosen for implementation, then a training process involving few-shot ICL may be utilized (this may be denoted as a first training process), which is further described below. In contrast, if a multi-modal LLM with open-source weights (this may be denoted as a second multi-modal LLM) is chosen for implementation, then another training process involving meta-learning may be utilized (this may be denoted as a second training process), which is also further described below.

An example multi-modal LLM with proprietary weights may be, but is not limited to, a multi-modal LLM comprising a generative pre-trained transformer neural network operating with proprietary weights. The first training process for the multi-modal LLM with propriety weights (i.e., the first multi-modal LLM) may include constructing a prompt based on a prompt technique comprising a reasoning and an action (ReAct) prompt technique. The ReAct prompt technique is a prompting technique that enables a LLM, such as the first multi-modal LLM, to generate dynamic traces correlating to the LLM's reasoning and task-specific actions.

The first training process may also include training iteratively the first multi-modal LLM with the constructed prompt based on a few-shot ICL process in generating a next virtual action associated with a current graphic user interface (GUI) state to complete the virtual task request.

That is, a prompt may be constructed using the ReAct prompting technique to specially guide the multi-modal LLM with proprietary weights in its iterative training to determine and generate a next virtual action based on the current GUI state to complete the virtual task request, e.g., a user-assigned task.

Continuing with the first training process, the few-shot ICL process may be utilized because it is a proven effective in training the multi-modal LLM with the proprietary weights. The few-shot ICL process may include deconstructing a predetermined number of a demonstration of a user performing the virtual action on a training computer screen into a series of sequences. The series of sequences may include a screenshot of the training computer screen, filtering of hypertext markup language (HTML) elements on the training computer screen, and a selection by the user of the HTML elements. The predetermined number of the demonstration may include up to two user demonstrations.

That is, in an example of the few-shot ICL process as part of the first training process, a user demonstration of a virtual task on the computer screen, e.g., a target webpage/website/domain, may be deconstructed into a series of sequences such as, but not limited, a screenshot of the training computer screen, HTML elements, and selection by the user of the HTML elements and include these series of sequences as the few-show ICL process example with the prompt derived from the ReAct prompting technique.

Continuing with the framework 500, the second training process may involve meta-learning if the implemented multi-modal LLM is based on open-source weights. The second training process may involve training the multi-modal LLM based on open-source weights (i.e., the second multi-modal LLM) based on a meta-learning technique that may include a first-order approximation of a model agnostic meta-learning technique.

Meta-learning, often dubbed “learning to learn”, is a training strategy in which a model learns to adjust efficiently to unseen tasks by leveraging knowledge gained from updates across many related tasks. Within meta-learning, model-agnostic meta-learning may refer to a meta-learning approach that can be applicable to any machine learning model.

Mathematically, the meta-learned model θ* can be obtained via meta-updates

$$θ ← θ - β \cdot {∇}_{θ} {\sum }_{i}^{N} {ℒ}_{{𝒯}_{i}} ( {θ}_{i} )$$

(denoted as an outer loop update process), wherein β is the meta-learning step size and the gradient is derived from the sum of losses L_{T}_{ᵢ}(θᵢ) across all tasks. Each θᵢ can be initialized from θ and fine-tuned on task Tᵢ, via θᵢ←θ−α·∇_{θ}L_{T}_{ᵢ}(θ) (denoted as an inner loop update process), with a being the step size. Thus, each meta-update involves meta-gradients (i.e., gradients through gradients).

However, since the present application may involve a multi-modal LLM with billions of parameters, computing meta-gradients can be computationally challenging. Therefore, a first-order approximation of a model-agnostic meta-learning (FOMAML) process can be computed instead. The performance of FOMAML is on par with MAML due to the predominantly locally linear nature of neural networks (wherein the multi-modal LLM is a type of neural network) making the second-order gradients negligible. Therefore, the present application computes meta-learning updates using FOMAML. The derivation of FOMAML and the meta-learning updates as they relate to generating the multi-modal LLM computer task automation agent is described below.

The derivation involves contextualizing an initial MAML algorithm (equation 1) to enable an updating of multi-modal LLM in generating the contextualizing it to our setting of updating multimodal LLMs. As such, equation 1 shows the initial expression for meta-learning updates using the MAML algorithm as shown below.

$$θ ← θ - β \cdot {∇}_{θ} {\sum }_{i = 1}^{N} {ℒ}_{{𝒯}_{i}} ( {θ}_{i} ) \qquad ( 1 )$$

Using the chain rule, the derivative term can be expressed as

$${\sum }_{i = 1}^{N} ( {∇}_{θ} {θ}_{i} \times {∇}_{{θ}_{i}} {ℒ}_{{𝒯}_{i}} ( {θ}_{i} ) ) .$$

The first component within the summation could be broken down further as, ∇_{θ}θᵢ=∇_{θ}(≥−α·∇_{θ} [symbol] ^{train}(θ)), where [symbol] ^{train} denotes the loss on the examples used for training θᵢ from task Tᵢ and α denotes the step-size in the inner loop of meta-training.

The above equation further simplifies to

$${∇}_{θ} {θ}_{i} = I - α \cdot {∇}_{θ}^{2} {ℒ}^{train} ( θ ) .$$

Assuming that the second-order derivatives in the expression can go to zero, then ∇_{θ}θᵢ=I. Plugging that into the initial MAML expression as shown in equation 1 resulting in the equation below, which may be denoted as equation 2.

$$θ ← θ - β \cdot {\sum }_{i = 1}^{N} {∇}_{{θ}_{i}} {ℒ}_{{𝒯}_{i}} ( {θ}_{i} ) \qquad ( 2 )$$

Essentially, this means that the inner loop of the meta-learning process involves fine-tuning the multi-modal LLM (i.e., θ→θᵢ) on virtual tasks Tᵢ from a given computer screen. The multi-modal LLM may be the second multi-modal LLM with open-source weights. This subset of tasks used for the inner loop update process of the training process (i.e., the second training process) may be denoted as

$${𝒟}_{i}^{train} .$$

Following this, the parameters of the multi-modal LLM θ may be updated by backpropagating the gradients of the loss at δᵢ, wherein the loss may be computed on held-out virtual tasks from the same computer screen which may be denoted as.

It should be emphasized that the gradients being backpropagated are computed at θᵢ (as opposed to θ, which would have resulted in training the multi-modal LLM on

$${𝒟}_{i}^{train} and {𝒟}_{i}^{test} ) .$$

In other words, the multi-modal LLM as represented by θ may be trained on

$${𝒟}_{i}^{train}$$

to obtain θᵢ and then update its original parameters θ using penalties computed by evaluating how far θᵢ is from the “ideal answers” on held-out

$${𝒟}_{i}^{test} .$$

If exposed to enough updates over varying-but-related computer screens with e.g., webpages/websites iϵ{1, . . . , N}, the updates to the multi-modal LLM agent θ would be positioned such that it would learn to adapt to unseen computer screens with e.g., webpages/websites quickly in a data-efficient manner. In an example, quickly may be measured in fractions or portions of a second or seconds.

Thus, when generating the multi-modal LLM computer task automation agent based on the second training process with meta-learning, the inner loop update process involves fine-tuning the multi-modal LLM (θ→θᵢ) on web tasks Tᵢ from a given computer screen, with the training subset used for this inner loop update process denoted as

$${𝒟}_{i}^{train} .$$

The second training process may also include updating the second multi-modal LLM by updating parameters of the second multi-modal LLM based on an outer loop update process of the meta-learning technique that backpropagates loss gradients. For the outer loop update process, the parameters of the multi-modal LLM as represented by θ may be updated by backpropagating the gradients of the loss at θᵢ, wherein the loss is computed on held-out virtual tasks from the same computer screen, which may be denoted as

$${𝒟}_{i}^{test} .$$

Importantly, the gradients being backpropagated are computed at θᵢ (rather than θ), ensuring the multi-modal LLM is not being trained on both

$${𝒟}_{i}^{train} and {D}_{i}^{t e s t}$$

in generating the multi-modal LLM computer task automation agent. Essentially, as represented by θ may be trained on

$${𝒟}_{i}^{train}$$

to obtain θᵢ and then update its original parameters θ using penalties based on how well θᵢ performs on held-out

$${𝒟}_{i}^{test} .$$

A better θ* serves as a better starting point to arrive at better θᵢ through fine-tuning, leading to less penalties on held-out

$${𝒟}_{i}^{test} .$$

This ensures quick and data-efficient adaptation of the multi-modal LLM computer task automation agent to an unseen computer screen.

The second training process involving FOMAML provides a technological process by overcoming the limited abilities of a general-purpose multi-modal LLM to process graphic user interface (GUI) snapshots. GUI snapshots involve complex layout understanding, optical character recognition (OCR), and functional understanding of hypertext markup language (HTML) elements. The second training process involving FOMAML provides a mechanism in generating the multi-modal LLM computer task automation agent via training and adapting the multi-modal LLM computer task automation agent such that it can process the GUI snapshots.

Experiments may be conducted to evaluate the multi-modal LLM computer task automation agent generated via the training processes as described above and shown in the framework 500. Datasets may be used to evaluate the quick adaptation capabilities of the multi-modal LLM computer task automation agent. Using the datasets, experiments may be designed that require adaptation of the multi-modal computer task automation agent to unseen computer screens with e.g., unseen websites and domains. In an example, two common benchmarks may be used: (1) the first benchmark may involve standardized training datasets and test datasets (and thus also may be referred to as the standardized benchmark) and (2) the second benchmark may involve a simulated live environment of several different websites' datasets (and thus also may be referred to as the simulated benchmark).

The first benchmark may provide standardized training datasets and test datasets across various websites and domains. For instance, the training dataset may include, but is not limited to: 1,009 tasks from 73 different websites and 3 domains. The training dataset of the first benchmark may include 1,009 task instances spanning 73 websites from three domains: travel, entertainment, and shopping. These tasks may involve various user goals such as booking flights, purchasing tickets, shopping for products, etc. Each task may be accompanied by detailed annotations, including the user instruction, the sequence of actions required to complete the task, and the corresponding HTML and visual states of the computer screens with e.g., various webpages.

The test dataset may be categorized into cross-tasks (e.g., 174 tasks from 64 seen websites), cross-websites (e.g., 142 tasks from 10 unseen websites), and cross-domains (e.g., 694 tasks from 2 unseen domains) subsets to evaluate different aspects of generalization.

That is, the test dataset may be divided into three subsets to facilitate the evaluation of models in different generalization scenarios: (a) cross-task subset, (b) cross-website subset, and (c) cross-domain subset. The cross-task subset may contain e.g., 174 tasks from the 64 websites that are present in the training set. The tasks in the cross-task subset may be different from those in the training dataset, but occur on familiar websites and within the same domains. The cross-website subset may include e.g., 142 tasks from 10 websites that are entirely unseen during training. The websites in the cross-website subset may belong to the same domains as those in the training dataset. The cross-domain subset may include, e.g., 694 tasks spanning 53 websites from two new domains: information and service. These domains are not present in the training dataset, and the websites are entirely new to the multi-modal LLM computer task automation agent.

Since the cross-task evaluation dataset may overlap with the training dataset, minor amendments are made to ensure proper evaluation of adaptability. Notably, the standardized cross-task evaluation dataset may exhibit overlap with the tasks in the training dataset, which could potentially inflate the evaluation results of the experiment by testing on tasks that might not truly be unseen. For instance, when the Jaccard similarity (i.e., intersection-over-union of unique unigrams) is computed between all the tasks in the standardized training dataset and the cross-task test set, pairs of highly similar tasks have been found spread across the two sets. In an example, the task “add Prometheus movie to watchlist” (from the training dataset) and the task “add The Wire to the watchlist” (from the cross-task dataset) may be highly similar tasks. In another example, the task “find a cheapest flight from London to New York on 9th May” (from the training dataset) and the task “find cheapest flight from New York to Toronto, Canada on 29 April” (from the cross-task dataset) may be highly similar tasks.

Thus, these overlaps between the training dataset and cross-task subset of the testing datasets should be addressed and fixed. To address and fix this issue, a first step may be to combine all the tasks within the existing training dataset and cross-task subsets of the standardized benchmark and compute a pairwise Jaccard similarity between all the tasks that belong to the same website. For each website, the K tasks that exhibited least maximum similarity with any other task from the website may then be moved to construct the amended cross-task dataset, while keeping the rest of the tasks from the website in the amended training dataset. The value of K can be determined so as to ensure that the amended training datasets and the cross-task subset had the same number of data points as the original training datasets and cross-task subset.

The overlap between the amended train cross-task datasets may also be qualitatively inspected, wherein it may be found that even the most similar tasks (based on unigram Jaccard similarity) across the two sets were now considerably different. For example, the task “show me all the events at any six flags park in Texas” (from the amended training dataset) and the task “show me all the artists with smith in their name” (from the amended cross-task subset) are now considerably different. In another example, the task “add to my cart a women's T-shirt priced under 10 dollars” (from the amended training dataset) and the task “list Batman collectible figures priced under 10 dollars and a customer rating above 4 with a same-day delivery option” (from the amended cross-task subset) are also now considerably different. This simple yet important amendment to the standardized benchmark's training dataset and cross-task subset ensures minimal overlap between tasks seen during training of the multi-modal LLM computer task automation agent and tasks that they are evaluated on in the cross-task setting.

Continuing with the second benchmark, the simulated live environment may simulate a live environment of e.g., three different websites (a social news aggregation website, classifieds website, and a shopping website) to evaluate task success rates of the multi-modal LLM computer task automation agent. The entire second benchmark (which may include up to, e.g., 910 tasks) may be used to test the adaptability of the multi-modal LLM computer task automation agent to unseen websites. While some tasks have step-level ground truth, other tasks may provide an overall task success signal based on the simulated live environment's state.

The second benchmark may include e.g., 910 tasks representing 233 unique task templates spread across the three different websites. Out of the 910 tasks, 233 tasks (one for each task template) may have step-level ground truth available in the form of user trajectories. These trajectories provide detailed action sequences that a user would take to accomplish the task, serving as a reference for evaluating the multi-modal LLM computer task automation agent's performance at each step. The remaining tasks might not have step-level ground truth, but may still provide an overall task success signal based on the simulated live environment's state after the multi-modal LLM computer task automation agent's interaction.

With the first and second benchmarks, an experimental protocol may be constructed for developing and evaluating the adaptability of the multi-modal LLM computer task automation agent. The experimental protocol may vary based on whether the base multi-modal LLM being implemented has either proprietary weights or open-source weights. That is, whether the implemented base multi-modal LLM used to generate the multi-modal LLM computer task automation agent is based on a multi-modal LLM comprising proprietary weights (which may be denoted as a first multi-modal LLM) or a multi-modal LLM comprising open-source weights (which may be denoted as a second multi-modal LLM).

For the multi-modal LLM comprising proprietary weights (i.e., the first multi-modal LLM), a prompting method that involves constructing a prompt based on the ReAct prompt technique and includes one few-shot ICL process example from the website or domain to which the multi-modal LLM computer task automation agent should adapt. This few-shot ICL process example may act as a one-shot (n=1) user demonstration, which may be denoted as 1-ICMD for 1 in-context multi-modal demonstration.

A one-shot setting for ICL may be utilized due to the trade-off between time and incremental accuracy improvements. While the present application has experimented with increasing the number of ICMDs, the benefits are minimal. For instance, experiments were performed to examine the impact of increasing the number of ICMDs, e.g., from 1 to 3, 5, and 10, that were performed on e.g., 30 sample tasks with ReAct prompting across cross-task, cross-website, and cross-domain settings in the first benchmark. Although performance does improve slightly with more demonstrations, the gains are minimal. Thus, given the trade-off between time and incremental accuracy improvements, it would be preferable to utilize a lower IMCD, such as a single IMCD.

Returning to the 1-IMCD case, the selection of the few-shot ICL process example ensures relevance to the cross-task, cross-website, and cross-domain evaluation setups. Specifically, for first benchmark's cross-task and cross-website evaluation, a random sample of one task from the same website (for cross-task) or from each unique website (for cross-website) in the test dataset may be performed along with an evaluation of the remaining examples from that website to maintain website-level correspondence. For cross-domain evaluation, a random sample of one task from each unique domain in the cross-domain test dataset may be formed along with an evaluation of the remaining examples from that domain. See FIG. 6, which may show a visual depiction of the various subsets.

Continuing with the 1-IMCD case, the specific prompts used in experiments may involve ReAct prompt technique with variants, including the modifications to include (text-only/multimodal) ICL user demonstrations. The prompt design may be shown in Table 1 below.

TABLE 1
Example prompt design for an in-context multi-modal demonstration (ICMD).

```
  (... preceded by the ReAct prompt...)
  To begin with, here is a quick example of one of the many tasks you could be performing
  on the website
  <website_name>.
  Example task's description: <task_description>
  To do this task, you could take the steps shown below.
  <Image depicting the GUI snapshot at this stage>
  ELEMENT:
  <element_name_1>
  ACTION: <action_type_1>
  VALUE:
  <value_if_applicable_1>
  <Image depicting the GUI snapshot at this stage>
  ELEMENT:
  <element_name_2>
  ACTION: <action_type_2>
  VALUE:
  <value_if_applicable_2>
  ...
  This marks the end of an example task and its steps. Now, let's move on to the task at
  hand.
(... followed by the ReAct prompt...)
```

Continuing with the multi-modal LLM comprising proprietary weights (i.e., the first multi-modal LLM), the second benchmark (i.e., the simulated live environment) evaluation may involve a randomly chosen one task as part of the ICL process with a user demonstration from the website for evaluation.

For the multi-modal LLM comprising open-source weights (i.e. the second multi-modal LLM), the evaluation of the second multi-modal may be further described in FIG. 6.

FIG. 6 illustrates an example evaluation strategy 600 for a meta-learning process as part of generating a multi-modal LLM computer task automation agent for autonomous execution of a virtual action according to an embodiment as described in FIG. 4 at steps S402-S403.

For the multi-modal LLM comprising open-source weights (i.e. the second multi-modal LLM), the example evaluation strategy 600 for meta-learning may involve several tasks (e.g., four tasks) that may be sampled per website from the e.g., 73 websites in the standardized benchmark training dataset, such as: two tasks for adaptation (Dᵢ^{train}) and two tasks for Dᵢ^{train} (one from the same website and one from a different website within the same domain) for computing the adaptation loss and updating the multi-modal LLM computer task automation agent's parameters.

After the meta-learning process (such as the FOMAML), the meta-trained multi-modal LLM can adapt to new websites in the cross-website test dataset by fine-tuning on the two tasks from each website and then evaluating on the remaining tasks. For cross-domain evaluation, the multi-modal LLM may be adapted based on the two tasks from each new domain and evaluate on the rest of the tasks within that domain (see the example evaluation strategy 600). Website adaptation for the cross-task test dataset is not performed because all websites are seen during meta-learning.

Continuing with the multi-modal LLM comprising open-source weights (i.e., the second multi-modal LLM), the second benchmark (i.e., the simulated live environment) evaluation may involve adapted the meta-trained multi-modal LLM on the standardized benchmark's training dataset, using two tasks from each of the three websites and evaluating on the remaining tasks. To control for the effect of the adaptation tasks, average results across five independent runs with different task selections may be reported. Overall, the process may involve meta-learning training (such as FOMAML) of the multi-modal LLM with e.g., 292 tasks from the standardized benchmark (e.g., 73 websites×4 tasks) and adapting the multi-modal LLM with two demonstrations to new websites/domains.

The example evaluation strategy 600 may show a visual depiction of the protocol used for meta-learning using the standardized benchmark's training dataset (left), and the meta-learning adaptation performed on cross-domain and cross-website evaluation datasets (top right). For completeness, conventional fine-tuning strategy is also depicted (bottom right).

Several meta-learning strategies may be utilized that can be applicable to the FOMAML process. One strategy may utilize intra-website, wherein the multi-modal LLM may be trained on few tasks within a website and adapted to more tasks on the same site. Another strategy may be inter-website, wherein the multi-modal LLM may be trained on tasks from one website and adapted to tasks from others in the same domain. Yet another strategy may be hybrid, which combines both of the previous strategies, adapting the multi-modal LLM to tasks within and across websites in the domain.

The processes as described in FIGS. 5 and 6 may be implemented on e.g., a remote or virtual server with e.g., eight graphics processing units (GPUs) each having e.g., 24 gigabytes. The eight GPUs being tailored for performing artificial intelligence (AI) computations.

Additionally, the implementation may also include filtering the top-K (e.g., top 50) HTML elements to be included in the prompt. Furthermore, for updating the multi-modal LLM's parameters during fine-tuning, meta-learning, and adaptation, Low-Rank Adaptation (LoRA) process may be implemented with the following example hyper-parameters: rank a of 20 and learning rate of 1e-5. For fine-tuning, the multi-modal LLM may be trained e.g., for 2 epochs.

Continuing with the implementation, for the meta-learning process, a meta-batch size of 1 may be used, wherein the multi-modal LLM computer task automation agent may be adapted to 1 website during the inner-loop update process. Additionally, one gradient optimization step for each step of the two tasks may be used for loss computation within the inner-loop update process. For adaptation to new websites and domains, the same strategy to adopt one gradient step optimization per step of the two sampled tasks may be used to maintain consistency with the training regime.

The performance of multi-modal LLM computer task automation agent may be evaluated using evaluation metrics. For evaluation on the standardized benchmark test datasets, since the ground-truth user trajectories are available for each task, granular metrics may be computed.

One granular metric may include an accuracy metric associated with predicting the correct HTML element to act on (i.e., element accuracy). For example, an HTML element might be a radio button, a search box, a title, etc. It is HTML element on the website upon which an action can be performed on, notably an autonomous action by the multi-modal LLM computer task automation agent.

Another granular metric may include a F₁ score associated with predicting a correct virtual action operation (which may be denoted as Op. F₁) such as click, select, type, etc. That is, a correct virtual operation on the computer screen.

Another granular metric may include aa percentage of successful steps (which may be denoted as step SR). For example, the successful steps may include requiring correct prediction of the element, the operation, and the optional type/selection text. The step SR may denote a first success rate percentage associated with autonomously performing the virtual action.

Another granular metric may include a percentage of successful virtual tasks (which may be denoted as overall SR), wherein task-level success is achieved only if the entire sequence of steps predicted by the multi-modal LLM computer task automation agent aligns with the ground-truth user trajectories. The overall SR may denote a second success rate percentage associated with the completion of the virtual task request.

For the second benchmark involving simulated live environment, since the ground-truth user trajectories are available only for a subset of the data (e.g., 233 tasks corresponding to the unique templates) and the rest of the tasks have only a task-level success signal within the live environment, the overall SR may be used as a primary metric while also quantifying the granular metrics specifically for the subset of tasks with user trajectories.

Experimental results show that the few-shot adaptation improved the performance of both the multi-modal LLM with proprietary weights and the multi-modal LLM with open-weights across the first and second benchmarks and all settings involving adaptation to unseen computer screens, e.g., unseen websites or domains. That is, regardless of the whether the implemented multi-modal LLM used in generating the multi-modal LLM computer task automation agent has proprietary weights or open-source weights, an improvement can be seen as a result of the few-shot learning.

Specifically, for the first benchmark's cross-website dataset and cross-domain dataset, few-shot learning with ICL process using the processes and techniques described above resulted in an increase in the overall success rate of the multi-modal LLM computer task automation agent ranging from e.g., 4.18% to 7.21% over the corresponding unadapted counterparts. This corresponds to a relative increase of 21.03% to 45.40% over the current LLM agents and their approaches in the status quo. The trends are consistent across the multi-modal LLMs in the present application, demonstrating the effectiveness of using only 1 or 2 user demonstrations as part of the few-shot learning with ICL process.

Similarly, on second benchmark, the multi-modal LLM computer task automation agent's performance has an increase in the overall success rate ranging from 3.36% to 5.11% as compared to the unadapted counterparts. This corresponds to 28.32% to 65.75% relative increase over the status quo approaches and their LLM agents. In Appendix A.5, we provide further investigations on the effect of few-shot adaptation on tasks of varying difficult levels, the role of number of in-context demonstrations used, the advantage of multimodal in-context demonstrations compared to text-only ones, and the role of different data selection strategies during meta-learning.

Ablation studies were also performed. The ablation studies compared text only demonstrations versus multi-modal in-context demonstrations (IMCD). Significant performance enhancements were observed with IMCD as compared to text-only versions. Notably, an improvement of several percentage points for the overall SR metric, i.e., with the relative gains from text to IMCD ranging from 4.28% to 23.76% (absolute gains of 0.95% to 3.78%) on the standardized benchmark and from 9.05% to 11.71% (absolute gains of 1.86% to 2.24%) on the simulated benchmark. These findings demonstrate the advantage of incorporating richer multi-modal ICL demonstrations, including visual snapshots, as compared to relying solely on text when training the multi-modal LLM.

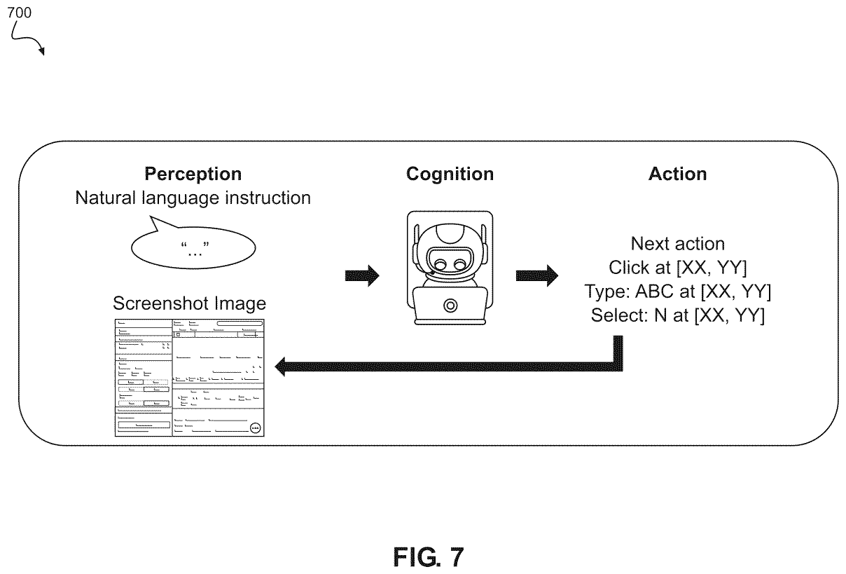

FIG. 7 illustrates an example general overview process 700 for generating a multi-modal LLM computer task automation agent for autonomous execution of a virtual action according to an embodiment as described in FIG. 4 at steps S401-404.

For instance, the example general overview process 700 may show an input data comprising a perception with an instruction in any modality (e.g., natural language instruction, voice/speech/audio, text, etc.). In an example, a virtual task request may be provided via natural language, such that a natural language instruction is generated. The input may also include a screenshot of a computer screen with e.g., a webpage/website associated with the virtual task request. This input data may then be provided to a cognition model, which may be the multi-modal LLM computer task automation agent. Upon receiving the input data, the cognition model may then make a prediction regarding a virtual next action on a computer screen, e.g., clicking action, typing action, and/or a selection action. The cognition model may then autonomously perform the virtual next action on the computer screen.

Although the invention has been described with reference to several embodiments, it is understood that the words that have been used are words of description and illustration, rather than words of limitation. Changes may be made within the purview of the attached claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the attached claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the attached claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of generating a multi-modal large language model computer automation agent for autonomous execution of a virtual action, the method being implemented by at least one processor, the method comprising:
receiving an input data comprising a virtual task request and a screenshot of a computer screen associated with the virtual task request;
implementing a multi-modal large language model (LLM) based on at least one from among a first multi-modal LLM comprising proprietary weights and a second multi-modal LLM comprising open-source weights;
generating a multi-modal LLM computer automation agent based on the implemented multi-modal LLM by performing at least one from among a first training process corresponding to the first multi-modal LLM and a second training process corresponding to the second multi-modal LLM; and
executing the multi-modal LLM computer automation agent to autonomously perform a virtual action on the computer screen to complete the virtual task request.

2. The method of claim 1, wherein the input data further comprises at least one from among a speech data and an audio data; and
wherein the virtual action comprises at least one from among a clicking action, a typing action, and a selection action.

3. The method of claim 1, wherein the first training process comprises:
constructing a prompt based on a prompt technique comprising a reasoning and an action (ReAct) prompt technique; and
training iteratively the first multi-modal LLM with the constructed prompt based on a few-shot in-context learning (ICL) process in generating a next virtual action associated with a current graphic user interface (GUI) state to complete the virtual task request.

4. The method of claim 3, wherein the few-shot ICL process comprises deconstructing a predetermined number of a demonstration of a user performing the virtual action on a training computer screen into a series of sequences;
wherein the series of sequences comprise a screenshot of the training computer screen, filtering of hypertext markup language (HTML) elements on the training computer screen, and a selection by the user of the HTML elements; and
wherein the predetermined number of the demonstration comprises a number of up to two.

5. The method of claim 1, wherein the second training process comprises:
training the second multi-modal LLM based on a meta-learning technique comprising a first-order approximation of a model agnostic meta-learning technique;
fine-tuning the second multi-modal LLM based on an inner loop update process of the meta-learning technique that fine-tunes the second multi-modal LLM on at least one virtual task from the computer screen; and
updating the second multi-modal LLM by updating parameters of the second multi-modal LLM based on an outer loop update process of the meta-learning technique that backpropagates loss gradients.

6. The method of claim 1, further comprising evaluating the generated multi-modal LLM computer task automation agent based on a success rate percentage associated with the completion of the virtual task request.

7. The method of claim 1, further comprising evaluating the generated multi-modal LLM computer task automation agent based on granular metrics comprising:
an accuracy metric associated with a correct prediction of a hypertext markup language (HTML) element on the computer screen for the autonomously performing of the virtual action,
a F1 score associated with a correct virtual action,
a first success rate percentage associated with the autonomously performing the virtual action, and
a second success rate percentage associated with the completion of the virtual task request.

8. A computing apparatus for generating a multi-modal large language model computer task automation agent for autonomous execution of a virtual action, comprising:
a processor;
a memory;
a display; and
a communication interface coupled to each of the processor, the memory, and the display, wherein the processor is configured to:
receive an input data comprising a virtual task request and a screenshot of a computer screen associated with the virtual task request;
implement a multi-modal large language model (LLM) based on at least one from among a first multi-modal LLM comprising proprietary weights and a second multi-modal LLM comprising open-source weights;
generate a multi-modal LLM computer task automation agent based on the implemented multi-modal LLM by performing at least one from among a first training process corresponding to the first multi-modal LLM and a second training process corresponding to the second multi-modal LLM; and
execute the multi-modal LLM computer task automation agent to autonomously perform a virtual action on the computer screen to complete the virtual task request.

9. The computing apparatus of claim 8, wherein the input data further comprises at least one from among a speech data and an audio data; and
wherein the virtual action comprises at least one from among a clicking action, a typing action, and a selection action.

10. The computing apparatus of claim 8, wherein the processor is further configured to perform the first training process by:
constructing a prompt based on a prompt technique comprising a reasoning and an action (ReAct) prompt technique; and
training iteratively the first multi-modal LLM with the constructed prompt based on a few-shot in-context learning (ICL) process in generating a next virtual action associated with a current graphic user interface (GUI) state to complete the virtual task request.

11. The computing apparatus of claim 8, wherein the processor is further configured to train iteratively the first multi-modal LLM with the constructed prompt based on the few-shot IC L process by:
deconstructing a predetermined number of a demonstration of a user performing the virtual action on a training computer screen into a series of sequences;
wherein the series of sequences comprise a screenshot of the training computer screen, filtering of hypertext markup language (HTML) elements on the training computer screen, and a selection by the user of the HTML elements; and
wherein the predetermined number of the demonstration comprises a number of up to two.

12. The computing apparatus of claim 8, wherein the processor is further configured to perform the second training process by:
training the second multi-modal LLM based on a meta-learning technique comprising a first-order approximation of a model agnostic meta-learning technique;
fine-tuning the second multi-modal LLM based on an inner loop update process of the meta-learning technique that fine-tunes the second multi-modal LLM on at least one virtual task from the computer screen; and
updating the second multi-modal LLM by updating parameters of the second multi-modal LLM based on an outer loop update process of the meta-learning technique that backpropagates loss gradients.

13. The computing apparatus of claim 8, wherein the processor is further configured to evaluate the generated multi-modal LLM computer task automation agent based on a success rate percentage associated with the completion of the virtual task request.

14. The computing apparatus of claim 8, wherein the processor is further configured to evaluate the generated multi-modal LLM computer task automation agent based on granular metrics comprising:
an accuracy metric associated with a correct prediction of a hypertext markup language (HTML) element on the computer screen for the autonomously performing of the virtual action,
a F1 score associated with a correct virtual action,
a first success rate percentage associated with the autonomously performing the virtual action, and
a second success rate percentage associated with the completion of the virtual task request.

15. A non-transitory computer readable storage medium storing instructions for generating a multi-modal large language model computer task automation agent for autonomous execution of a virtual action, the non-transitory computer readable storage medium comprising executable code which, when executed by a processor, causes the processor to:
receive an input data comprising a virtual task request and a screenshot of a computer screen associated with the virtual task request;
implement a multi-modal large language model (LLM) based on at least one from among a first multi-modal LLM comprising proprietary weights and a second multi-modal LLM comprising open-source weights;
generate a multi-modal LLM computer task automation agent based on the implemented multi-modal LLM by performing at least one from among a first training process corresponding to the first multi-modal LLM and a second training process corresponding to the second multi-modal LLM; and
execute the multi-modal LLM computer task automation agent to autonomously perform a virtual action on the computer screen to complete the virtual task request.

16. The non-transitory computer readable storage medium of claim 15, wherein the input data further comprises at least one from among a speech data and an audio data; and
wherein the virtual action comprises at least one from among a clicking action, a typing action, and a selection action.

17. The non-transitory computer readable storage medium of claim 15, wherein the executable code further causes the processor to perform the first training process by:
constructing a prompt based on a prompt technique comprising a reasoning and an action (ReAct) prompt technique; and
training iteratively the first multi-modal LLM with the constructed prompt based on a few-shot in-context learning (ICL) process in generating a next virtual action associated with a current graphic user interface (GUI) state to complete the virtual task request.

18. The non-transitory computer readable storage medium of claim 15, wherein the executable code further causes the processor to train iteratively the first multi-modal LLM with the constructed prompt based on the few-shot IC L process by:
deconstructing a predetermined number of a demonstration of a user performing the virtual action on a training computer screen into a series of sequences;
wherein the series of sequences comprise a screenshot of the training computer screen, filtering of hypertext markup language (HTML) elements on the training computer screen, and a selection by the user of the HTML elements; and
wherein the predetermined number of the demonstration comprises a number of up to two.

19. The non-transitory computer readable storage medium of claim 15, wherein the executable code further causes the processor to perform the second training process by:
training the second multi-modal LLM based on a meta-learning technique comprising a first-order approximation of a model agnostic meta-learning technique;
fine-tuning the second multi-modal LLM based on an inner loop update process of the meta-learning technique that fine-tunes the second multi-modal LLM on at least one virtual task from the computer screen; and
updating the second multi-modal LLM by updating parameters of the second multi-modal LLM based on an outer loop update process of the meta-learning technique that backpropagates loss gradients.

20. The non-transitory computer readable storage medium of claim 15, wherein the executable code further causes the processor to evaluate the generated multi-modal LLM computer task automation agent based on granular metrics comprising:
an accuracy metric associated with a correct prediction of a hypertext markup language (HTML) element on the computer screen for the autonomously performing of the virtual action,
a F1 score associated with a correct virtual action,
a first success rate percentage associated with the autonomously performing the virtual action, and
a second success rate percentage associated with the completion of the virtual task request.
